(19) United States
(12) Patent Application Publication
(10) Pub. No.: US 2020/0350636 A1
(43) Pub. Date: Nov. 5, 2020

(54) BATTERY MODULE AND BATTERY PACK

(71) Applicant: Contemporary Amperex Technology Co., Limited, Ningde City (CN)

(72) Inventors: Xianchun ZHU, Ningde City (CN); Chao ZENG, Ningde City (CN); Hua CAO, Ningde City (CN); Chong WANG, Ningde City (CN)

(73) Assignee: Contemporary Amperex Technology Co., Limited, Ningde City (CN)

(21) Appl. No.: 16/691,940

(22) Filed: Nov. 22, 2019

(30) Foreign Application Priority Data
Apr. 30, 2019 (CN) 201920620796.9

(51) Int. Cl. H01M 10/42; H01M 2/12; H01M 10/48

(52) U.S. Cl. CPC H01M 10/4257; H01M 2/1241; H01M 2220/20; H01M 10/486; H01M 2/1282

(57) ABSTRACT

The present disclosure relates to a battery module and a battery pack. The battery module includes a battery assembly, including a plurality of battery cells arranged in an array, wherein each of the battery cells includes a vent; a circuit board, including a plurality of sampling terminals connected to the battery cells and being capable of collecting electrical parameters and/or temperature parameters of the battery cells; and a thermal cable, located between the battery assembly and the circuit board and fixedly coupled to the circuit board, wherein a thermal circuit is formed inside the thermal cable, and the thermal circuit can provide a prompt signal indicating a bursting of the vent of any of the battery cells. When a thermal runaway of any of the battery cells occur, the corresponding vent bursts to heat the thermal cable, and the thermal cable can quickly sense a temperature change.

### CROSS REFERENCE TO RELATED APPLICATION

This application claims priority to Chinese Patent Application No. 201920620796.9, filed on Apr. 30, 2019, which is hereby incorporated by reference in its entirety.

### TECHNICAL FIELD

The present disclosure relates to a technical filed of batteries, and particularly relates to a battery module and a battery pack.

### BACKGROUND

As energy densities of a power battery and an energy storage battery increase, requirements on safety of the batteries become higher and higher. In a battery pack, a thermal runaway of a battery cell may occur when the battery cell is misused. When the thermal runaway occurs, a high temperature and fire may be formed quickly, which may bring great damage, and easily cause a great safety accident.

In the existing module design of the power battery and the energy storage battery, merely voltages and temperature signals of some of the battery cells are collected and transmitted for sampling of the battery cells, which cannot effectively and accurately provide and transmit a prompt signal indicating the thermal runaway of the battery cell, to the outside.

### SUMMARY

The embodiments of the present disclosure disclose a battery module and a battery pack, which can provide a signal indicating a thermal runaway of a battery cell.

On one aspect, the embodiments of the present disclosure discloses a battery module, including: a battery assembly, including a plurality of battery cells arranged in an array, wherein each of the battery cells includes a vent; a circuit board, including a plurality of sampling terminals connected to the battery cells and being capable of collecting electrical parameters and/or temperature parameters of the battery cells; and a thermal cable, located between the battery assembly and the circuit board and fixedly coupled to the circuit board, wherein a thermal circuit is formed inside the thermal cable, and the thermal circuit can provide a prompt signal indicating a bursting of the vent of any of the battery cells.

According to one aspect of the embodiments of the present disclosure, the thermal cable includes a wire forming the thermal circuit and an insulating layer surrounding an outer periphery of the wire, and the insulating layer of the thermal cable is melted when the vent of any of the battery cells bursts, so as to short-circuit the thermal circuit and provide the prompt signal.

According to one aspect of the embodiments of the present disclosure, the battery module further includes a cover block, extending in a first direction and provided with at least an accommodating portion penetrating the cover block in the first direction, wherein the thermal cable is at least partially accommodated in the accommodating portion, and the cover block is coupled to the circuit board.

According to one aspect of the embodiments of the present disclosure, the battery module further includes a connecting member, including an abutting portion and a clamping portion connected with each other; and the circuit board includes a first surface facing away from the battery assembly and a second surface facing the battery assembly, and the circuit board is provided with a hole penetrating the first surface and the second surface, wherein the abutting portion abuts against the first surface, and the clamping portion passes through the hole and clamps the cover block.

According to one aspect of the embodiments of the present disclosure, the abutting portion includes a third surface facing the circuit board, and the clamping portion includes a first protrusion and a second protrusion protruding from the third surface, wherein the first protrusion and the second protrusion are spaced apart from each other with a clamping space formed between them, and the cover block is located in the clamping space; and the cover block abuts against the second surface of the circuit board.

According to one aspect of the embodiments of the present disclosure, the abutting portion has a fourth surface facing away from the circuit board, and is provided with a recess on the third surface, wherein the recess is recessed toward the fourth surface of the abutting portion and is capable of accommodating a portion of the circuit board.

According to one aspect of the embodiments of the present disclosure, each of the battery cells includes an electrode, and the battery module further includes a busbar for connecting the electrodes of the battery cells, and the sampling terminals of the circuit board are connected to the battery cells via the busbar; and the abutting portion extends in a second direction, which intersects with the first direction, and has two end portions opposite to each other in the second direction, wherein each of the two end portions is provided with a snap member on the third surface, and the snap member can be coupled to the battery cell and/or the busbar in a snap fit manner.

According to one aspect of the embodiments of the present disclosure, the snap member includes a snap groove, which is engaged with the battery cell and/or the busbar in a snap fit manner and includes a snap surface abutting against the battery cell and/or the busbar, wherein a distance of the snap surface to the second surface of the circuit board is smaller than a thickness of the cover block.

According to one aspect of the embodiments of the present disclosure, the accommodating portion is formed as a channel extending in the first direction, and the cover block has a fifth surface facing the circuit board, wherein the channel is provided with an opening located at the fifth surface and has an inner wall surface in a shape matching with a shape of an outer peripheral surface of the thermal cable.

According to one aspect of the embodiments of the present disclosure, the thermal cable is interference-fitted with the accommodating portion.

According to one aspect of the embodiments of the present disclosure, the cover block is formed as an elastic block.

According to one aspect of the embodiments of the present disclosure, the thermal cable has a projection passing through the vents of the plurality of battery cells, on a plane where the vents of the plurality of battery cells are located.

On a further aspect, the embodiments of the present disclosure discloses a battery pack, including a battery module according to any of the above embodiments and a battery management system module, wherein the thermal cable of the battery module is electrically connected to the battery management system module.

On a further aspect, the embodiments of the present disclosure proposes a vehicle including a battery pack according to any of the above embodiments, wherein the battery management system module is adapted to send an alarm signal to a vehicle system of the vehicle when the vent of any of the battery cells bursts.

The battery module according to the embodiments of the present disclosure includes a thermal cable fixedly coupled to the circuit board, and a thermal circuit is formed inside the thermal cable and can provide a prompt signal indicating a bursting of a vent of any of the battery cells. The thermal cable is electrically connected to a BMS module. When no thermal runaway of any of the battery cells occurs and the battery cells operate normally, the thermal circuit formed inside the thermal cable has resistance or may be connected with a resistance in series, and a rated resistance of the thermal cable can be detected by the BMS module. When a thermal runaway of any of the battery cells occur, the corresponding vent bursts to heat the thermal cable, and the thermal cable can quickly sense a temperature change. When the temperature exceeds a predetermined threshold, the thermal circuit inside the thermal cable is short-circuited or open-circuited. A short-circuit signal or an open-circuit signal can be used as a prompt signal, and can accurately and effectively transmit an information that the thermal runaway of the battery cell occurs, to the outside, thereby improving the safety of the battery module in use.

In some optional embodiments, the thermal cable includes a wire forming the thermal circuit and an insulating layer surrounding an outer periphery of the wire. When a thermal runaway of any of the battery cells occurs, the corresponding vent bursts to heat the thermal cable. After a temperature of the thermal cable exceeds a predetermined threshold, the insulating layer is melted. As a result, some regions of the wire forming the thermal circuit are overlapped and connected, and thus a short circuit occurs. The short-circuit signal can be used as a prompt signal, and can accurately and effectively transmit an information that the thermal runaway of the battery cell occurs, to the outside.

### BRIEF DESCRIPTION OF THE DRAWINGS

Other features, advantages, and technical effects of the present disclosure will become more apparent by reading the following detailed description on non-limiting embodiments with reference to accompanying drawings, wherein the same or similar reference numerals indicate the same or similar features.

FIG. 1 is a perspective view showing a battery module according to an embodiment of the present disclosure;

FIG. 2 is an exploded perspective view of a battery module according to an embodiment of the present disclosure;

FIG. 3 is a perspective view of a battery module with a battery assembly and a cover plate removed according to an embodiment of the present disclosure;

FIG. 4 is an exploded perspective view of a battery module with a battery assembly and a cover plate removed according to an embodiment of the present disclosure;

FIG. 5 is a schematic structural view of a portion of a thermal cable according to an embodiment of the present disclosure;

FIG. 6 is a cross-sectional view taken along line A-A of FIG. 3;

FIG. 7 is a cross-sectional view taken along line B-B of FIG. 4;

FIG. 8 is a perspective view of a connecting member in a battery module according to an embodiment of the present disclosure;

FIG. 9 is a cross-sectional view taken along line C-C of FIG. 3;

FIG. 10 is a partially enlarged schematic view of portion D in FIG. 3;

FIG. 11 is a partially enlarged schematic view of portion E in FIG. 4.

In the accompanying drawings:
1—battery module;
11—battery assembly; 111—battery cell; 1111—vent; 1112—electrode;
12—circuit board; S1—first surface; S2—second surface; 121—body portion; 122—sampling terminal; 12h—hole;
13—thermal cable; 131—wire; 132—insulating layer; 139—electrical connector;
14—cover block; S5—fifth surface; 141—accommodating portion;
15—connecting member;
151—abutting portion; S3—third surface; S4—fourth surface; 151a—end portion; 1511—recess;
152—clamping portion; 1521—first protrusion; 1522—second protrusion; 1523—clamping space;
153—snap member; 1531—snap groove; S6—snap surface;
16—busbar;
17—cover plate; 171—cover connecting member;
X—first direction; Y—second direction;
L—distance from the snap surface to the second surface of the circuit board.

### DETAILED DESCRIPTION

Features of various aspects and specific embodiments of the present disclosure will be further described in detail below. In order to make technical objects, technical solutions and advantages of the present disclosure to be more apparent, the present disclosure is further described in detail with reference to the accompanying drawings and specific embodiments. It should be understood that, the specific embodiments described herein are only to be construed as illustrative and not limiting. To the person skilled in the art, the present disclosure may be practiced without some of the specific details. The following description of the embodiments is merely made to provide a better understanding of the present disclosure.

It should be noted that, in this context, terms such as “first” and “second” are used merely to distinguish one entity or operation from another entity or operation, and do not necessarily require or imply any actual relationship or order between the entities or operations. Further, terms “comprise”, “include” or any other variations thereof are intended to encompass a non-exclusive inclusion, such that a process, method, article, or device including a plurality of elements, includes not only the plurality of elements, but also other elements not specifically listed, or other elements that are inherent to such a process, method, article, or device. The element that is defined by the phrase “includes . . . ”, without other limitations, does not exclude the presence of additional identical elements in the process, method, article, or device including this element.

It should be understood that when describing a configuration of a component, a layer or region being disposed “above” or “on” another layer or region, means that the layer or region is directly on another layer or region, or that there is other layer or region between the layer or region and another layer or region. Moreover, if the component is reversed, the layer or region will be located “below” or “under” another layer or region.

The embodiment of the present disclosure discloses a battery module and a battery pack, wherein the battery pack may include a battery module and a battery management system (BMS) module for managing the battery module and battery cells in the battery module, and detecting operation states of the battery module and the battery cells in the battery module.

Hereinafter, a battery module according to an embodiment of the present disclosure will be described in detail with reference to the accompanying drawings.

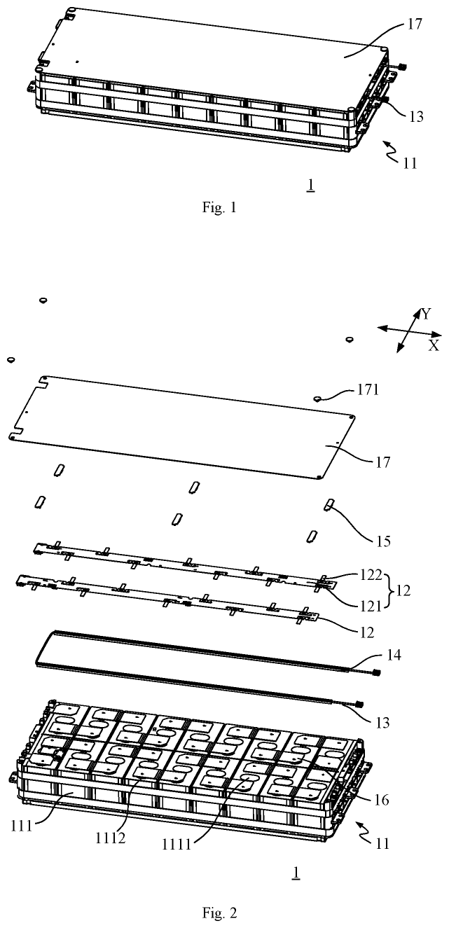

FIG. 1 and FIG. 2 respectively show a perspective view and an exploded perspective view of a battery module according to an embodiment of the present disclosure. The battery module 1 includes a battery assembly 11, a circuit board 12, etc.

The battery assembly 11 includes a plurality of battery cells 111 arranged in an array, and each of the battery cells 111 includes a vent 1111 and an electrode 1112. Each battery cell 111 may be a prismatic cell and includes a cap assembly, wherein the vent 1111 and the electrode 1112 may be disposed on the cap assembly. The plurality of battery cells 111 may be arranged in at least one row. In the present embodiment, the description is made by taking an example in which the plurality of battery cells 111 is arranged in two rows. In each row, a plurality of battery cells 111 are stacked in a thickness direction.

The circuit board 12 includes a body portion 121 and a plurality of sampling terminals 122, and the sampling terminals 122 are connected to the battery cells 111 and can collect electrical parameters and/or temperature parameters of the battery cells 111. In some embodiments, the circuit board 12 is a Flexible Printed Circuit (FPC). In some embodiments, the sampling terminals 122 may extend outward from the body portion 121 to facilitate connection with the battery cells 111. There may be one circuit board 12, or two or more circuit boards 12. In some embodiments, one circuit board 12 is disposed corresponding to each row of the battery cells 111 on a side thereof provided with the electrodes 1112.

The circuit board 12 may be electrically connected to the BMS module of the battery pack. For example, the circuit board 12 collects voltage signals and temperature signals of the battery cells 111, and transmits them to the BMS module.

In some embodiments, the sampling terminals 122 may be connected to the electrodes 1112 of the battery cells 111. Further, in some embodiments, the battery module 1 further includes a busbar 16 for connecting the electrodes 1112 of the battery cells 111, and the sampling terminals 122 of the circuit board 12 is connected to the battery cells 111 via the busbar 16.

In some embodiments, the battery module 1 may include a frame assembly to provide a space for accommodating the plurality of battery cells 111, and to provide protection for the accommodated battery cells 111 and other components. In the present embodiment, the battery module 1 includes a cover plate 17, which serves as at least a portion of the frame assembly on a side of the battery assembly 11 provided with the electrodes 1112.

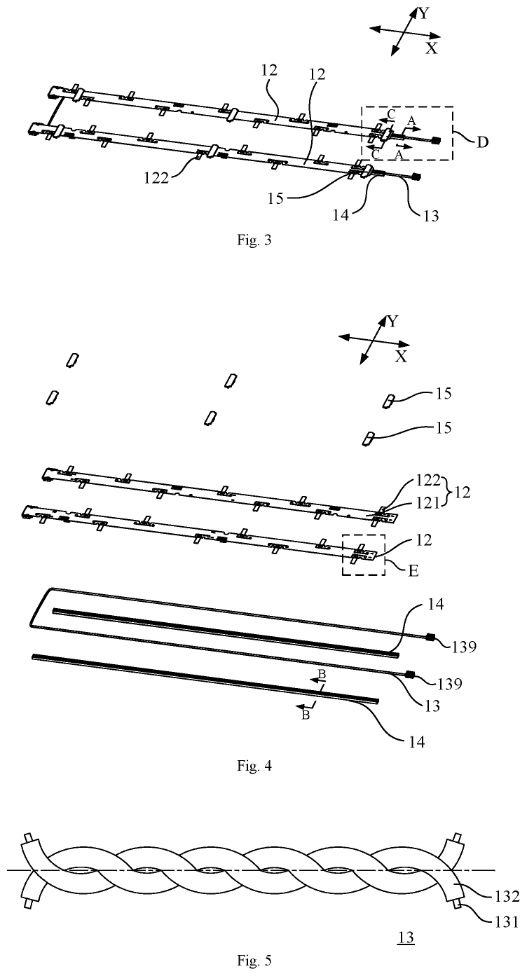

FIG. 3 and FIG. 4 are respectively a perspective view and an exploded perspective view of the battery module 1 with the battery assembly and the cover plate removed according to an embodiment of the present disclosure.

In the present embodiment, the battery module 1 further includes a thermal cable 13. The thermal cable 13 is located between the battery assembly 11 and the circuit board 12 and is fixedly coupled to the circuit board 12. Inside the thermal cable 13, a thermal circuit is formed, to provide a prompt signal indicating a bursting of the vent 1111 of any of battery cells 111.

During the use of the battery module 1, a thermal runaway of the battery cell 111 included therein may occur in some cases, and when the thermal runaway occurs, the vent 1111 of the corresponding battery cell 111 bursts. Herein, the bursting of the vent 1111 means that the vent 1111 is opened and a high-temperature gas, a high-temperature electrolyte or a spark is ejected when the thermal runaway of the battery cell 111 occurs, releasing a large amount of heat to an upper and peripheral space of the battery cell. By detecting whether or not the vent 1111 bursts, it can be known whether or not a thermal runaway of the corresponding battery cell 111 occurs.

According to the battery module 1 of the embodiment of the present disclosure, when a thermal runaway of any of the battery cells 111 occurs, the vent 1111 of the corresponding battery cell bursts to heat the thermal cable 13, and the thermal cable 13 can quickly sense a temperature change. When the temperature exceeds a predetermined threshold, the thermal circuit inside the thermal cable 13 is short-circuited or open-circuited. A short-circuit signal or an open-circuit signal can be used as a prompt signal, and can accurately and effectively transmit an information that the thermal runaway of the battery cell 111 occurs, to the outside, thereby improving safety of the battery module 1 in use.

In the battery pack including the battery module 1 according to the embodiment of the present disclosure, the thermal cable 13 may be electrically connected to the BMS module, that is, the thermal circuit formed inside the thermal cable 13 is electrically connected to the BMS module. When no thermal runaway of any of the battery cells 111 occurs and the battery cells 111 operate normally, the thermal circuit formed inside the thermal cable 13 has resistance or may be connected with a resistance in series, and a rated resistance of the thermal cable 13 may be detected by the BMS module. When a thermal runaway of any of the battery cells 111 occurs, the corresponding vent 1111 bursts to heat the thermal cable 13, and the thermal cable 13 can quickly sense a temperature change. When the temperature exceeds a predetermined threshold, the thermal circuit inside the thermal cable 13 is short-circuited or open-circuited. A short-circuit signal or an open-circuit signal may be transmitted to the BMS module as a prompt signal, and can accurately and effectively transmit an information that the thermal runaway of the battery cell 111 occurs, to the outside, thereby improving the safety of the battery module 1 in use.

In some embodiments, the battery module 1 and the battery pack are applied to a vehicle as a power source. When a thermal runaway of any of the battery cells 111 occurs, a prompt signal is provided by the thermal cable 13 and is transmitted to the BMS module, and the BMS module can quickly send an alarm signal to a vehicle system, thereby ensuring that the personnel in the vehicle have enough time to get away from the vehicle, avoiding the personnel in the vehicle from being damaged by the fire caused by the thermal runaway of the battery cell, and thus improving reliability and safety of the battery module 1 and the battery pack in the application.

In the present embodiment, the plurality of battery cells 111 in the battery module 1 are arranged in two rows, and the vents 1111 of each row of the battery cells 111 are arranged in line. In the present embodiment, the thermal cable 13 extends in a U-shape, and a projection of the thermal cable 13 on a plane where the vents 1111 of the plurality of battery cells 111 are located, passes through the vents 1111 of the plurality of battery cells 111. In some embodiments, the thermal cable 13 may be disposed immediately above the vents 1111 of the battery cells 111, so that the thermal cable 13 can be quickly heated and thus quickly provide the above-mentioned prompt signal, when the vent 111 of at least one of the battery cells 111 gets abnormal and bursts.

It can be understood that, in other embodiments, depending on the arrangement of the plurality of battery cells 111, the extending manner of the thermal cable 13 can be accordingly adjusted.

In the present embodiment, the thermal cable 13 extends in the U-shape, and may be provided with electrical connectors 139 at two ends. In some embodiments, the thermal circuit of the thermal cable 13 is electrically connected to the BMS module via the electrical connectors 139.

FIG. 5 shows a schematic structural view of a portion of the thermal cable according to an embodiment of the present disclosure, in which a segment of the thermal cable 13 is taken. The thermal cable 13 may be formed as a twisted-pair cable, and includes a wire 131 forming the thermal circuit and an insulating layer 132 surrounding an outer periphery of the wire 131. In some embodiments, at least one fixed resistor may be connected in series to the thermal circuit formed inside the thermal cable 13. In the present embodiment, the insulating layer 132 of the thermal cable 13 is melted when the vent 1111 of any of the battery cells 111 bursts so as to short-circuit the thermal circuit and thus provide a prompt signal.

Specifically, when a thermal runaway of any of the battery cells 111 occurs, the corresponding vent 1111 bursts to heat the thermal cable 13. After the temperature of the thermal cable 13 exceeds the predetermined threshold, the insulating layer 132 is melted. As a result, some regions of the wire 131 forming the thermal circuit are overlapped and connected, and thus a short circuit occurs. The short-circuit signal can be used as a prompt signal, and can accurately and effectively transmit an information that the thermal runaway of the battery cell occurs, to the outside (for example, BMS module).

As shown in FIGS. 1 to 4, in some embodiments, the battery module 1 further includes a cover block 14. The cover block 14 extends in a first direction X, and is coupled to the circuit board 12. In some embodiments, the first direction X is parallel to a direction in which the battery cells 111 in each row are stacked.

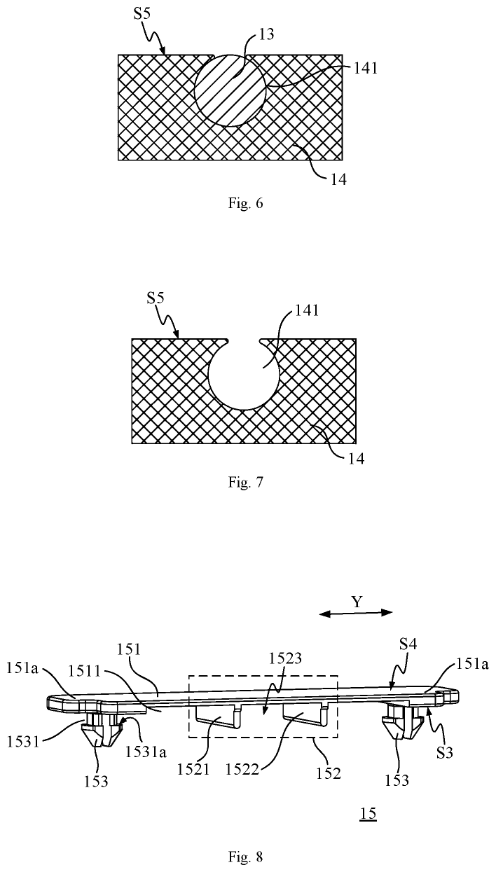

FIG. 6 is a cross-sectional view taken along line A-A of FIG. 3, and FIG. 7 is a cross-sectional view taken along line B-B of FIG. 4. The cover block 14 is provided with at least an accommodating portion 141 penetrating the cover block 14 in the first direction X, and the thermal cable 13 is at least partially accommodated in the accommodating portion 141. The cover block 14 is coupled to the circuit board 12 so as to achieve fixing and integration of the thermal cable 13 with the circuit board 12.

In some embodiments, the cover block 14 is an elastic block. For example, the cover block 14 is made of a foam material, and has a certain flexibility and elasticity. In the present embodiment, as an intermediate connecting member, the cover block 14 provides an assembling platform and space for the circuit board 12 and the thermal cable 13. Meanwhile, by means of the unique elasticity and flexibility of the cover block 14, the reliability of the components in all the operating conditions of the battery module can be ensured.

In some embodiments, the accommodating portion 141 may be formed as a passage in the cover block 14 extending in the first direction X, or may be formed as a through groove in the cover block 14 extending in the first direction X.

In the present embodiment, the accommodating portion 141 is formed as a channel extending in the first direction X. The cover block 14 has a fifth surface S5 facing the circuit board 12, and the channel is provided with an opening located at the fifth surface S5. Further, the channel has an inner wall surface in a shape matching with a shape of an outer peripheral surface of the thermal cable 13, so that the thermal cable 13 can be accommodated in the channel more stably. By forming the accommodating portion 141 as a channel with an opening, it is convenient to assemble and disassemble the thermal cable 13 with the cover block 14. The opening of the channel is located on the fifth surface S5 facing the circuit board 12, and thus can be closed after the cover block 14 is fixedly coupled to the circuit board 12, thereby avoiding a separation of the thermal cable 13 from the cover block 14 in use.

In some embodiments, the thermal cable 13 is interference-fitted with the accommodating portion 141 to achieve the fixing of the thermal cable 13 and satisfy the requirements on the thermal cable 13 under various operating conditions in a vibrating environment.

As shown in FIGS. 1 to 4, in some embodiments, the battery module 1 further includes a connecting member 15. FIG. 8 shows a perspective view of a connecting member in a battery module 1 according to an embodiment of the present disclosure, wherein the connecting member 15 includes an abutting portion 151 and a clamping portion 152 that are connected to each other. In some embodiments, the connecting member 15 may be made of a plastic material.

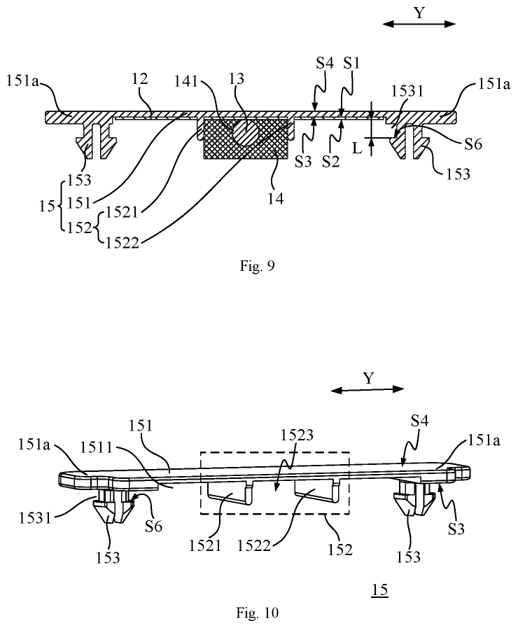

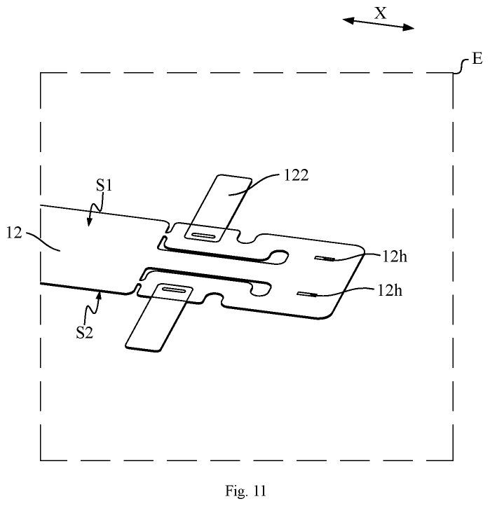

FIG. 9 is a schematic cross-sectional view taken along line C-C of FIG. 3. FIG. 10 is a partially enlarged schematic view of portion D in FIG. 3, in which a view angle in FIG. 10 is adjusted with respect to FIG. 3 to clearly show configurations of the components. FIG. 11 is a partially enlarged schematic view of portion E in FIG. 4.

In the present embodiment, the circuit board 12 includes a first surface S1 facing away from the battery assembly 11 and a second surface S2 facing the battery assembly 11. As shown in FIG. 11, the circuit board 12 is provided with a hole 12h penetrating the first surface S1 and the second surface S2. In some embodiments, a hole 12h is provided on the body portion 121.

In some embodiments, the abutting portion 151 of the connecting member 15 abuts against the first surface S1 of the circuit board 12, and the clamping portion 152 of the connecting member 15 passes through the hole 12h and clamps the cover block 14.

In some embodiments, the abutting portion 151 has a third surface S3 facing the circuit board 12, and the clamping portion 152 includes a first protrusion 1521 and a second protrusion 1522 that protrude from the third surface S3. The first protrusion 1521 and the second protrusion 1522 are spaced apart from each other with a clamping space 1523 formed between them, and the cover block 14 is located in the clamping space 1523. In some embodiments, when the cover block 14 is clamped in the clamping space 1523, the cover block 14 abuts against the second surface S2 of the circuit board 12.

In some embodiments, the abutting portion 151 has a fourth surface S4 facing away from the circuit board 12, and the connecting member 15 is provided with a recess 1511 on the third surface S3, which is recessed toward the fourth surface S4 of the abutting portion 151 and can accommodate a portion of the circuit board 12. By providing the recess 1511 to accommodate a portion of the circuit board 12, a thickness of a coupling assembly formed by the connecting member 15, the circuit board 12, the cover block 14 and the thermal cable 13 can be reduced, thereby increasing a space utilization rate within the battery module.

In some embodiments, the abutting portion 151 extends in a second direction Y, wherein the second direction Y intersects with the first direction X, and in some embodiments, the second direction Y may be perpendicular to the first direction X. The abutting portion 151 has two end portions 151a opposite to each other in the second direction Y. Each of the two end portions 151a is provided with a snap member 153 on the third surface S3, which can be coupled with the battery cell 111 and/or the busbar 16 in the battery module 1 in a snap fit manner.

In the battery module 1 according to the embodiment of the present disclosure, by means of the connecting member 15, the circuit board 12, the cover block 14 and the thermal cable 13 are coupled and the formed coupling assembly is fixedly coupled to the battery assembly 11 and/or the busbar 16 in a snap fit manner. As a result, there is no need to provide a wire harness isolation plate, an insulating sheet, etc., which can increase the space utilization rate, reduce a raw material cost of the circuit board 12, make the coupling assembly simpler and more convenient, and reduce assembly process of a factory line and the number of components, thereby effectively reducing a manufacturing cost.

In some embodiments, the snap member 153 includes a snap groove 1531 for engaging with the battery cell 111 and/or busbar 16 in a snap fit manner. The snap groove 1531 has a snap surface S6 abutting against the battery cell 111 and/or busbar 16. As shown in FIG. 9, in some embodiments, a distance L of the snap surface S6 to the second surface S2 of the circuit board 12 is smaller than a thickness of the cover block 14, wherein the thickness of the cover block 14 refers to a dimension of the cover block 14 in a direction perpendicular to the second surface S2. When the snap member 153 is engaged with the battery cell 111 and/or the busbar 16 in the snap fit manner, the cover block 14 is compressed in the thickness direction to a certain degree. Since the cover block 14 has elasticity, the snap-fit coupling of the connecting member 15, the circuit board 12, the cover block 14, the thermal cable 13 and the battery cell 111 and/or the busbar 16 is more stable and has better anti-vibration performance.

During an assembly of the above-described battery module 1, the thermal cable 13 can be assembled in the accommodating portion 141 of the cover block 14 in advance; then, the cover block 14 with the thermal cable 13 accommodated is disposed on the cap assemblies of the battery cells 111, and the circuit board 12 is correspondingly disposed on the cover block 14; and after that, the circuit board 12 and the cover block 14 are fixed to the battery cells 111 and/or the busbars 16 by the connecting member 15. Wherein, the abutting portion 151 of the connecting member 15 abuts against the first surface S1 of the circuit board 12, and the clamping portion 152 of the connecting member 15 passes through the holes 12h and clamps the cover block 14, thereby realizing the fixing of the connecting member 15, the circuit board 12, the cover block 14 and the thermal cable 13; and the connecting member 15 is engaged with the battery cell 111 and/or the busbar 16 via the snap member 153 in a snap fit manner, thereby realizing the fixing of the connecting member 15, the circuit board 12, the cover block 14 and the thermal cable 13 to the battery cells 111. Thereafter, the cover plate 17 can be assembled on the circuit board 12, and the cover plate 17 is fixedly coupled to the battery assembly 11 by a cover connecting member 171, thereby realizing assembly of the battery module 1.

In the above embodiments of the present disclosure, not all the details are described, and the present disclosure are not limited to the described specific embodiments. Obviously, many modifications and variations are possible in light of the above description. The above embodiments has been selected and described in detail to better explain the principles and practical applications of the present disclosure, so that the person skilled in the art can make a good use of the present disclosure and make modifications based on the present disclosure. The present disclosure is limited only by the claims and all the scopes and equivalents thereof.

What is claimed is:

1. A battery module, comprising:
a battery assembly, comprising a plurality of battery cells arranged in an array, wherein each of the battery cells comprises a vent;
a circuit board, comprising a plurality of sampling terminals connected to the battery cells and being capable of collecting electrical parameters and/or temperature parameters of the battery cells; and
a thermal cable, located between the battery assembly and the circuit board and fixedly coupled to the circuit board, wherein a thermal circuit is formed inside the thermal cable, and the thermal circuit can provide a prompt signal indicating a bursting of the vent of any of the battery cells.

2. The battery module according to claim 1, wherein the thermal cable comprises a wire forming the thermal circuit and an insulating layer surrounding an outer periphery of the wire, and the insulating layer of the thermal cable is melted when the vent of any of the battery cells bursts, so as to short-circuit the thermal circuit and provide the prompt signal.

3. The battery module according to claim 1, wherein further comprising:
a cover block, extending in a first direction and provided with at least an accommodating portion penetrating the cover block in the first direction, wherein the thermal cable is at least partially accommodated in the accommodating portion, and the cover block is coupled to the circuit board.

4. The battery module according to claim 3, wherein further comprising:
a connecting member, comprising an abutting portion and a clamping portion connected with each other; and
the circuit board comprises a first surface facing away from the battery assembly and a second surface facing the battery assembly, and the circuit board is provided with a hole penetrating the first surface and the second surface, wherein the abutting portion abuts against the first surface, and the clamping portion passes through the hole and clamps the cover block.

5. The battery module according to claim 4, wherein the abutting portion comprises a third surface facing the circuit board, and the clamping portion comprises a first protrusion and a second protrusion protruding from the third surface, wherein the first protrusion and the second protrusion are spaced apart from each other with a clamping space formed between them, and the cover block is located in the clamping space; and
the cover block abuts against the second surface of the circuit board.

6. The battery module according to claim 5, wherein the abutting portion has a fourth surface facing away from the circuit board, and is provided with a recess on the third surface, wherein the recess is recessed toward the fourth surface of the abutting portion and is capable of accommodating a portion of the circuit board.

7. The battery module according to claim 5, wherein each of the battery cells comprises an electrode, and
the battery module further comprises:
a busbar for connecting the electrodes of the battery cells, and the sampling terminals of the circuit board are connected to the battery cells via the busbar; and
the abutting portion extends in a second direction, which intersects with the first direction, and has two end portions opposite to each other in the second direction, wherein each of the two end portions is provided with a snap member on the third surface, and the snap member can be coupled to the battery cell and/or the busbar in a snap fit manner.

8. The battery module according to claim 7, wherein the snap member comprises a snap groove, which is engaged with the battery cell and/or the busbar in a snap fit manner and comprises a snap surface abutting against the battery cell and/or the busbar, wherein a distance of the snap surface to the second surface of the circuit board is smaller than a thickness of the cover block.

9. The battery module according to claim 3, wherein the accommodating portion is formed as a channel extending in the first direction, and the cover block has a fifth surface facing the circuit board, wherein the channel is provided with an opening located at the fifth surface and has an inner wall surface in a shape matching with a shape of an outer peripheral surface of the thermal cable.

10. The battery module according to claim 3, wherein the thermal cable is interference-fitted with the accommodating portion.

11. The battery module according to claim 3, wherein the cover block is formed as an elastic block.

12. The battery module according to claim 1, wherein the thermal cable has a projection passing through the vents of the plurality of battery cells, on a plane where the vents of the plurality of battery cells are located.

13. A battery pack, comprising:
a battery module according to claim 1; and
a battery management system module, wherein the thermal cable of the battery module is electrically connected to the battery management system module.

14. The battery pack according to claim 13, wherein the thermal cable comprises a wire forming the thermal circuit and an insulating layer surrounding an outer periphery of the wire, and the insulating layer of the thermal cable is melted when the vent of any of the battery cells bursts, so as to short-circuit the thermal circuit and provide the prompt signal.

15. The battery pack according to claim 13, wherein further comprising:
a cover block, extending in a first direction and provided with at least an accommodating portion penetrating the cover block in the first direction, wherein the thermal cable is at least partially accommodated in the accommodating portion, and the cover block is coupled to the circuit board.

16. The battery pack according to claim 15, wherein further comprising:
a connecting member, comprising an abutting portion and a clamping portion connected with each other; and
the circuit board comprises a first surface facing away from the battery assembly and a second surface facing the battery assembly, and the circuit board is provided with a hole penetrating the first surface and the second surface, wherein the abutting portion abuts against the first surface, and the clamping portion passes through the hole and clamps the cover block.

17. The battery pack according to claim 16, wherein the abutting portion comprises a third surface facing the circuit board, and the clamping portion comprises a first protrusion and a second protrusion protruding from the third surface, wherein the first protrusion and the second protrusion are spaced apart from each other with a clamping space formed between them, and the cover block is located in the clamping space; and
the cover block abuts against the second surface of the circuit board.

18. The battery pack according to claim 17, wherein the abutting portion has a fourth surface facing away from the circuit board, and is provided with a recess on the third surface, wherein the recess is recessed toward the fourth surface of the abutting portion and is capable of accommodating a portion of the circuit board.

19. The battery pack according to claim 17, wherein each of the battery cells comprises an electrode, and
the battery module further comprises:
a busbar for connecting the electrodes of the battery cells, and the sampling terminals of the circuit board are connected to the battery cells via the busbar; and
the abutting portion extends in a second direction, which intersects with the first direction, and has two end portions opposite to each other in the second direction, wherein each of the two end portions is provided with a snap member on the third surface, and the snap member can be coupled to the battery cell and/or the busbar in a snap fit manner.

20. A vehicle, comprising a battery pack according to claim 13, wherein the battery management system module is adapted to send an alarm signal to a vehicle system of the vehicle when the vent of any of the battery cells bursts.
